(19) United States
(12) Patent Application Publication
(10) Pub. No.: US 2011/0069024 A1
(43) Pub. Date: Mar. 24, 2011

(54) INPUT METHOD AND INPUT DEVICE OF PORTABLE TERMINAL

(75) Inventor: Jin Yong KIM, Seoul (KR)

(73) Assignee: SAMSUNG ELECTRONICS CO., LTD., Gyeonggi-Do (KR)

(21) Appl. No.: 12/854,413

(22) Filed: Aug. 11, 2010

(30) Foreign Application Priority Data
Sep. 21, 2009 (KR) 10-2009-0089202

(51) Int. Cl. G06F 3/041; G05B 23/02; G09G 5/00; G10L 11/00

(52) U.S. Cl. 345/173; 340/3.1; 345/156; 704/275; 704/E11.001

(57) ABSTRACT

An input method and device of a portable terminal is disclosed. If the pressure value corresponding to a mechanical force applied to the external body of the portable terminal is equal to or less than a preset value, the portable terminal ascertains that the current state is a grip state. If the pressure value is greater than the preset value, the portable terminal ascertains that a current state is a squeeze state. The command generated according to the grip state and the squeeze state is applied to a currently enabled application program.

### CLAIM OF PRIORITY

This application claims, pursuant to 35 USC 119, priority to and the benefit of the earlier filing date of, that patent application filed in the Korean Patent Office, entitled “Input Method and Input Device of Portable Terminal,” on Sep. 21, 2009 and afforded serial no. 10-2009-0089202, the entire contents of which are incorporated by reference, herein.

### BACKGROUND OF THE INVENTION

1. Field of the Invention

The present invention relates to portable terminals, and more particularly, to an input method and input device that generates a input signal according to pressure applied the portable terminal and a variety of input signals associated with other input systems.

2.Description of the Related Art

Portable terminals have been widely used because of their convenience in their functionality and their ability to be easily carried. Portable terminals employ a variety of input methods to provide user functions. For example, the terminals may be equipped with a touch screen, including a touch panel and a display unit. When the touch panel detects a user's touch on a particular image displayed on the display (e.g., an icon), a corresponding touch event is generated. In response to the touch event, the portable terminal controls the operation of an application program corresponding to the touch event.

However, conventional portable terminals are disadvantageous in that they allow the user to use a touch screen function in a state where the display unit is enabled. In addition, conventional portable terminals have also drawbacks in that their touch panel does not allow the user to generate a sophisticated touch event or apply a sophisticated touch event to the touch panel. Furthermore, since the conventional input signal generating method and system allows the user to carry out a touch action on a touch panel in a state where the touch screen is being enabled, the portable terminal cannot generate a variety of input signals. To overcome these conventional problems, an input method and input device that can generate input signals are required.

### SUMMARY OF THE INVENTION

The present invention has been made in view of the above problems, and provides an input method and input device that can generate a variety of input signals according to a pressure applied to one side of a portable terminal and generate an input based on the magnitude of the applied pressure and operate an application program, based on the generated input signal. In addition, a variety of application programs may be operated by associating with other functions, such as a touch function or a voice recognition function.

In accordance with an exemplary embodiment of the present invention, the present invention provides an input device of a portable terminal including: a sensing unit, a controller, and a storage unit. The sensing unit detects a pressure value corresponding to a mechanical force applied to the portable terminal. The controller determines whether the pressure value is equal to or less than a preset value. The controller ascertains that a current state is a grip state if the pressure value is equal to or less than the preset value and that the current state is a squeeze state if the pressure value is greater than the preset value. The controller generates commands according to the grip state and the squeeze state and applies the generated commands to a currently enabled application program. The storage unit stores the application program.

In accordance with another exemplary embodiment of the present invention, the present invention provides an input method of a portable terminal including: detecting a pressure value corresponding to a mechanical force applied to the portable terminal; determining whether the pressure value is equal to or less than a preset value; ascertaining that a current state is a grip state if the pressure value is equal to or less than the preset value and that the current state is a squeeze state if the pressure value is greater than the preset value; generating commands according to the ascertained grip state and the squeeze state; and applying the generated commands to a currently enabled application program.

In accordance with another aspect of the invention, a portable terminal is disclosed which comprises a processor in communication with a memory, the memory including code which when accessed by the processor causes the processor to: receive a pressure input from at least one pressure sensor; determine a pressure state, wherein a grip state is determined if the received pressure is less than or equal to a preset pressure and at least one sub-squeeze state if the received pressure is within a predetermined pressure range greater than the preset pressure; and access a command table stored in said memory, wherein said command table provides instruction to the processor based on the determined pressure state and a currently executed program.

### BRIEF DESCRIPTION OF THE DRAWINGS

The features and advantages of the present invention will become more apparent from the following detailed description in conjunction with the accompanying drawings, in which:

FIG. 1 shows a schematic block diagram illustrating a portable terminal according to an embodiment of the present invention;

FIG. 2 shows a condition where a user's hand holds a portable terminal according to an embodiment of the present invention;

FIG. 3 shows a detailed view illustrating the controller of FIG. 1;

FIG. 4 shows screen view that describes a first embodiment of the operation of the portable terminal according to the present invention;

FIG. 5 shows screen views that describe a second embodiment of the operation of the portable terminal according to the present invention;

FIG. 6 shows screen views that describe a third embodiment of the operation of the portable terminal according to the present invention;

FIG. 7 shows screen views that describe a fourth embodiment of the operation of the portable terminal according to the present invention;

FIG. 8 shows screen views that describe a fifth embodiment of the operation of the portable terminal according to the present invention;

FIG. 9 shows screen views that describe a sixth embodiment of the operation of the portable terminal according to the present invention;

FIG. 10 shows screen views that describe a seventh embodiment of the operation of the portable terminal according to the present invention; and

FIG. 11 shows a flow chart that describes an input method of a portable terminal according to an embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

Prior to explaining the embodiments of the present invention, terminologies will be defined for the present description below. The terms or words described in the present description and the claims should not be limited by a general or lexical meaning, instead should be analyzed as a meaning and a concept through which the inventor defines and describes the present invention to comply with the idea of the present invention. Therefore, one skilled in the art will understand that the embodiments disclosed in the description and configurations illustrated in the drawings are only preferred embodiments, and that there may be various modifications, alterations, and equivalents thereof to replace the embodiments at the time of filing this application that are considered to be within the scope of the invention as claimed.

In the following description, the term ‘grip state’ refers to a state where a user holds one side of a portable terminal, to which a sensing unit is installed, with less than or equal to a preset pressure value. One side of a portable terminal may be an external body. The term ‘squeeze state’ refers to a state where a user grips a sensing unit installed to one side of the portable terminal with greater than the preset pressure value. The grip state refers to a state where, for example, the preset pressure value is set at 1 N, and a pressure no greater than 1 N is applied to the sensing unit of the portable terminal. Similarly, the squeeze state refers to a state where an applied pressure of a value, 1.5 N, 2 N, 3 N, etc., which is greater than the preset value, is applied to the sensing unit. As would be appreciated, the squeeze state may further be divided into a plurality of states, wherein a first squeeze state signal may be generated when the pressure applied is between 1 N and 2 N, a second pressure state signal may be generated when the pressure applied is between 2 N and 3 N and a third pressure state signal may be generated when the pressure applied is between 3 N and 4 N. This progression of different squeeze state signals may be continued for a plurality of pressures. In addition, it would be recognized that the exemplary ranges shown herein may be adjusted to represent different ranges and such adjustment is considered to be within the scope of the invention claimed.

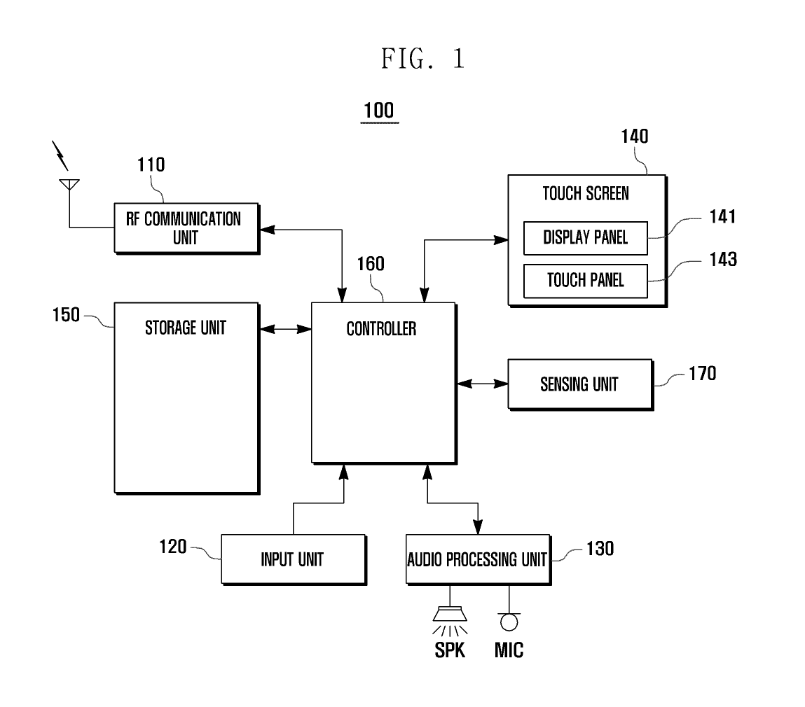

FIG. 1 shows a schematic block diagram illustrating a portable terminal according to an embodiment of the present invention.

Referring to FIG. 1, the portable terminal 100 includes an RF communication unit 110, an input unit 120, an audio processing unit 130, a touch screen 140, a storage unit 150, a sensing unit 170, and a controller 160.

The portable terminal 100 generates sensed signals, according to pressure values that a user applies to the sensing unit 170, and outputs them to the controller 160. The controller 160 generates a command to be applied to application programs currently enabled, according to the type of sensed signals. The portable terminal 100 executes the currently enabled application program according to the generated command. The portable terminal 100 can also generate a new command by combining the sensed signal with signals of its other functions, for example, a touch signal according to at least one of a touch function and a voice recognition signal according to a voice recognition function, or other similar inputs and then executes an application program based on the new command. The sensing unit 170 can generate sensed signals according to a magnitude of the pressure applied by the user's hand, etc. In the following description, each element of the portable terminal 100 is explained in detail.

The RF communication unit 110 establishes communication channels for performing a voice call and for transmitting data, such as video data, and performs corresponding communication via the channel under the control of the controller 160. The RF communication unit 110 establishes a voice call channel, a data communication channel, or a video call channel among mobile communication systems (not shown). To this end, the RF communication unit 110 includes an RF transmitter (not shown) for up-converting the frequency of signals to be transmitted and amplifying the to-be transmitted signals and an RF receiver (not shown) for low-noise amplifying received RF signals and down-converting the frequency of the received RF signals. The RF communication unit 110 can be operated by an application program enabled according to a sensed signal generated in the sensing unit 170. For example, if a user holds the external body of the portable terminal 100 with the sensing unit 170, the RF communication unit 110 may be enabled to establish connection (voice or data) to another communication device using a preset phone number. Likewise, if the user changes the grip state to a squeeze state of the portable terminal 100, i.e., holds the external body of the portable terminal 100 with a pressure value greater than the preset pressure value, in a state where the RF communication unit 110 is being enabled according to an incoming call, the RF communication unit 110 can establish a call channel based on the incoming call. The RF communication unit 110 can be selected according to a grip or squeeze-state sensing signal and a touch event generated on a touch panel 143 of the touch screen 140, under the control of the controller 160. The RF communication unit 110 can also be enabled according to a grip or squeeze-state sensing signal and a voice recognition signal. The RF communication unit 110 can be enabled or disenabled according to at least one of the grip-state sensing signal, the squeeze-state sensing signal, the touch event, and the voice recognition signal.

The input unit 120 includes a plurality of input keys and function keys that serve to receive numerical or alphabetical information and set a variety of functions. The function keys include direction keys, side keys, shortcut keys, etc., which are set to perform specific functions. The input unit 120 generates key signals related to a user's settings and the control of functions of the portable terminal 100 and outputs them to the controller 160. The input unit 120 may be implemented with a QWERTY keypad, a 3×4 keypad, a 4×3 keypad, etc. If the portable terminal 100 is implemented in such a way that the touch screen 140 is a full touch screen type, the input unit 120 can be replaced with the touch panel 143 and a keypad map displayed on the touch screen 140. The input signals, generated in the input unit 120, can be combined with signals generated in the sensing unit 170, i.e., a grip-state sensing signal or a squeeze-state sensing signal, and serves as a signal to generate a command for enabling a particular function of a currently enabled application program.

The audio processing unit 130 includes a speaker SPK for reproducing audio data during the call and a microphone MIC for receiving a user's voice during the call or audio signals. The voice signals acquired by the microphone MIC are recognized by the controller 160, according to the setting of a voice recognition function. The voice recognition signal recognized by the controller 160 can be combined with the grip or squeeze-state sensing signal, generated by the sensing unit 170, to generate a command for enabling a particular function of a currently enabled application program. The speaker SPK outputs audio signals corresponding to particular voice information stored in the storage unit 150, under the control of the controller 160. For example, if a grip or squeeze-state sensing signal is generated in a state where voice information for explaining a particular user function has been stored in the storage unit 150, the speaker SPK converts the voice information for explaining a user function, which can be operated according to a corresponding sensed signal, into audio signals and outputs them.

The touch screen 140 includes a display panel 141 and a touch panel 143. The touch screen 140 can be configured in such a way that the touch panel 143 is placed in front of the display panel 141. The size of the touch screen 140 is determined according to that of the touch panel 143.

The display panel 141 displays information input by the user and information to be provided to the user as well as various menus of the portable terminal 100. For example, the display panel 141 can display a variety of screens when the portable terminal 100 is operated, such as an idle screen, a menu screen, a message writing screen, a call screen, etc. The display panel 141 can also display icons or images corresponding to the user's functions. For example, if the portable terminal 100 provides a widget function and at least one menu function, the display panel 141 can display at least one widget icon corresponding to the widget function, at least one image or icon corresponding to the menu function, etc.

The display panel 141 may be implemented with a liquid crystal display (LCD), an organic light emitting diode (OLED), or the like. The display panel 141 may be smaller than the touch panel 143. The display panel 141 may be placed under the touch panel 143. In an embodiment of the present invention, the display panel 141 is comprised of display areas to which a particular function is applied according to a grip or squeeze-state sensing signal, which will be explained, in detail, later, with reference to the drawings.

The touch panel 143 is configured to cover the display panel 141. The touch panel 143 generates a touch event according to the touch or approach of an object and outputs a signal corresponding to the touch event to the controller 160. The touch panel 143 transfers location information where a touch (or the approach of an object) has occurred and information regarding the type of the touch event to the controller 160. The controller 160 identifies the location information and the type of the touch event, and also ascertains that a particular image is displayed on the corresponding location on the display panel 141. After that, the controller 160 enables a user function linked to the touched image. In an embodiment of the present invention, the touch event, generated on the touch panel 143, may be combined with at least one of the grip-state sensing signal and the squeeze-state sensing signal generated by the sensing unit 170, and the combination serves as a signal to generate a command to operate the portable terminal 100.

The storage unit 150 stores application programs required to operate the functions of the portable terminal 100. If the portable terminal 100 is implemented to include a touch screen, the storage unit 150 stores a key map, menu map, etc. to operate the touch screen. The key map and the menu map may be implemented with a variety of types. For example, the key map may be a keyboard map, a 3×4 key map, a QWERTY key map, etc. The key map can also be a control key map to operate an application program that is currently being enabled. Likewise, the menu map may be a map to operate an application program that is currently being enabled. The menu map may also be a map containing a variety of menu items to operate the portable terminal. The storage unit 150 may be configured to include a program storage area (not shown) and a data storage area (not shown).

The program storage area stores an operating system (OS) for booting the portable terminal 100 and operating elements included therein. The program storage area also stores application programs for reproducing a variety of files, such as an application program for supporting a voice call function, a web browser function for accessing an Internet server, an application program for audio sources, such as an MP3 file, an application program for reproducing photographs, images, moving images, etc. In an embodiment of the present invention, the program storage area stores a sensor operating program for operating a sensing unit, a touch operating program for supporting a touch function, a voice recognition program for supporting a voice recognition function, and a user interface (UI) operating program for applying a signal, processed by a corresponding operating program, to a currently enabled application program. Each of the programs can be accessed by the controller 160 when the portable terminal 100 is enabled and serves as a unit for supporting a corresponding function. For example, the sensor operating program includes a grip UI processing module, a squeeze UI processing module, and a routine for controlling power supplied to the sensing unit 170 and the transfer of sensed signals generated in the sensing unit 170. The touch operating program includes a touch UI processing module and a routine for mapping images, being displayed by a currently enabled application program, to a touch panel and for recognizing a touch event that occurs on a touch panel. The voice recognition program includes a voice UI processing module and a routine for recognizing a user's requested voice signals, acquired by the microphone MIC, based on a previously stored voice recognition database. The UI operating program includes a UI processing module and a command generating module. The UI processing module includes a routine that transfers signals, according to the activation of the grip UI processing module, a squeeze UI processing module, a touch UI processing module, and a voice UI processing module, to a command generating unit. The command generating module includes a routine for converting the signals from the UI processing module into a particular command based on a command table and applying it to an application program.

The data storage area stores data generated when the portable terminal 100 is operated. The data storage area stores phonebook information, a contact list, a to-do list, a calendar, and a variety of contents, etc. The data storage area can also store user data input via the touch screen 140. In an embodiment of the present invention, the data storage area includes a voice recognition database for recognizing voice recognized words and stores the acquired signals in a command table that is referred to when the signals are converted into particular commands.

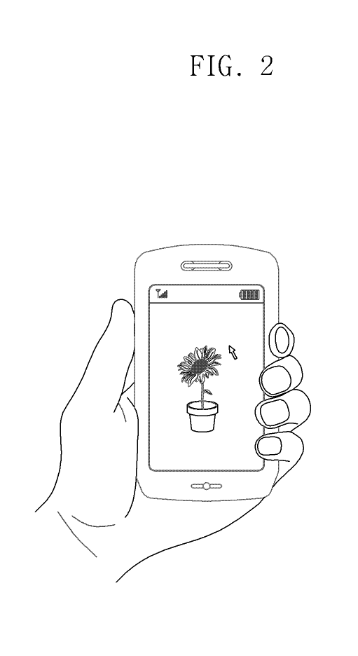

The sensing unit 170 is implemented with at least one piezoelectric sensor and installed to one side of the portable terminal 100. For example, the sensing unit 170 is implemented with a set of piezoelectric sensors that are installed on both sides of the touch screen 140, seen from the front of the portable terminal 100. For example, as shown in FIG. 2, if a user's left or right hand holds the portable terminal 100 where the terminal's left or right side is equipped with a certain number of piezoelectric sensors, the piezoelectric sensors can detect pressure values according to each finger's touch at a corresponding position. For example, the sensing unit 170 can be configured in such a way that four piezoelectric sensors are installed to one of the left and right sides, respectively, and being spaced apart at a same distance, in order to detect a left hand grip or a right hand grip. Therefore, the sensing unit 170 can detect a grip state where the fingers of the right or left hand are located at the piezoelectric sensors and can also detect a squeeze state when the fingers apply a pressure value greater than a preset value to the piezoelectric sensors. The sensing unit 170 can detect, step by step, the squeeze state as the fingers applies force, greater than the preset value, to the piezoelectric sensors. For example, if the fingers apply a total pressure of 1 N to the piezoelectric sensors, the sensing unit 170 can detect a grip state. Likewise, if the fingers apply a total pressure of 2 N to the piezoelectric sensors, the sensing unit 170 can detect a squeeze state. However, since the portable terminal user cannot precisely apply 1 N or 2 N to the piezoelectric sensors, the sensing unit 170 can be designed to detect a corresponding squeeze state if the detected pressure value is in a certain range of values (e.g., greater than 1N or in the range of 1N to 2N, 2N to 3N, etc.). If the sensing unit 170 detects a grip state or at least one squeeze state according to a user's applied force, the sensing unit 170 generates a corresponding grip-state sensing signal or at least one corresponding squeeze-state sensing signal and transfers the sensing signal to the controller 160.

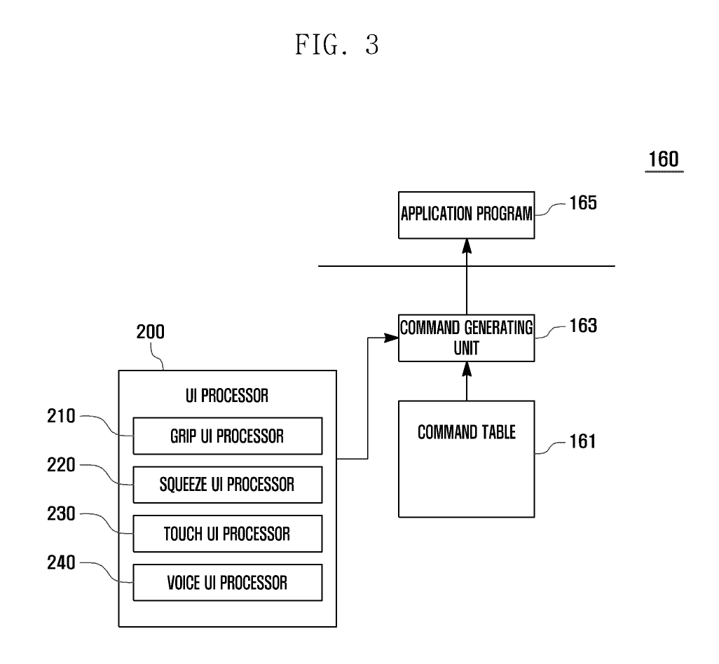

The controller 160 supplies electrical power to each element of the portable terminal 100 and initializes the elements of the portable terminal. After completing the initialization process, the controller 160 operates an application program for each element. The controller 160 can also control the application program and each element by combining the sensed signals, generated in the grip or squeeze state, with signals generated according to at least one of a touch function and a voice recognition function. To this end, as shown in FIG. 3, the controller 160 includes a UI processor 200, a command table 161, a command generating unit 163, and an application program 165. These configurations are stored in a format of module or a routine in the storage unit 150 and are accessed by the controller 160, according to a user's request or a mode set in the portable terminal, in order to perform a corresponding function.

The application program 165 serves to execute user functions that the portable terminal user can initiate. Examples of the user functions are a phonebook function, a camera function, a call function, a file playback function, a file search function, a web connection function, etc. The application program 165 performs a particular function according to a signal input via the input unit 120, a touch event that occurred on the touch screen 140 or a voice recognition signal according to a voice recognition function, etc. In particular, the application program 165 can perform a particular function according to a grip or squeeze state generated according to how the user holds the portable terminal. The application program 165 can perform a composite function according to the sensed signals, the touch event, the voice recognition signal, and the signal input to the input unit 120.

The command table 161 is stored in the storage unit 150 and loaded on the controller 160. The command table 161 can be retained in the storage unit 150 according to the design of the controller 160 and referred by the command generating unit 163. If a grip-state sensing signal, a squeeze-state sensing signal, a touch event, a voice recognition signal, and other types of input signals input via the input unit 120 are individually, independently or compositely generated, the command table 161 serves to provide a reference to generate commands for operating a currently enabled application program. For example, if a grip-state sensing signal is generated, the command table 161 contains a command for reporting that the touch panel 143 is locked. If squeeze-state sensing signal is generated, the command table 161 contains a command for changing a lock state into an unlock state. The command table 161 can also contain a command for performing a particular function according to the occurrence of a touch event or the input of a voice recognition signal in a state where the squeeze-state sensing signal has been generated. In one aspect of the invention, when the currently enabled program represents an image presentation program, an associated command table may translate different pressure values into corresponding different levels of zoom in/zoom out operations. Hence, more enlarged presentation of portions of a displayed image may be obtained by appropriate application of a pressure value(s) on the case. As it would be appreciated, the particular operations associated with different currently enabled programs may be preset by the device manufacturer or may be set by a user. The command generating unit 163 generates particular commands for operating the application program 165, by referring to the command table 161 based on the signals output from the UI processor 200. The command generating unit 163 applies the generated command to the application program 165.

The UI processor 200 configures at least one of a grip UI processor 210, a squeeze UI processor 220, a touch UI processor 230, and a voice UI processor 240, based on an application program stored in the storage unit 150, according to a user's request or the setting of the portable terminal. The UI processor 200 serves to link the processors 210, 220, 230, and 240 to the configuration of the hardware, respectively. The UI processor 200 converts mechanical force or audio signals generated from the configuration of the hardware into signals and transfers them to the command generating unit 163.

The grip and squeeze UI processors 210 and 220 receive a sensed signal from the sensing unit 170 and determine whether the sensed signal corresponds to a grip state or a squeeze state, referring to a preset reference value. In particular, the grip and squeeze UI processors 210 and 220 can determine which one of the states the sensed signal corresponds to. The grip and squeeze UI processors 210 and 220 generate signals based on the corresponding determination, and transfer the generated signals to the command generating unit 163. That is, the UI processor 210 determines signals, generated by the respective processors simultaneously or within a certain period of time, as a signal to generate one command, and transfers it to the command generating unit 163. The command generating unit 163 receives a signal or signals from the UI processor 200 and determines which command the received signals correspond to, referring to the command table 161, and then controls the application program 165 based on the command.

The touch UI processor 230 activates the touch panel 143 according to a user's request and the setting of the portable terminal 100 and determines a type of touch events that occurred on the touch panel 143, for example, a touch down event, a touch up event, a touch drag event, a flip event, etc. The touch UI processor 230 transfers a signal corresponding to the type of event to the command generating unit 163. During this process, if a particular signal is generated in another UI processor, the signal corresponding to the touch event of the touch UI processor 230 can be transferred to the command generating unit 163, together with the particular signal, under the control of the UI processor 200.

The voice UI processor 240 recognizes voice signals, acquired by the microphone MIC, based on a voice recognition database stored in the storage unit 150. The voice UI processor 240 transfers the recognized voice signals to the command generating unit 163. The voice UI processor 240 can be implemented with a variety of voice recognition algorithms. For example, the voice UI processor 240 can be implemented with a voice recognition algorithm where: a voice signal, acquired by the microphone MIC, is sampled at 16 KHz and quantized at 16 bits, the quantized voice data is processed by a transfer function and multiplied by a Hamming window of 25 ms; and it is analyzed by being shifted by 10 ms. Through this process, the voice characteristic parameter can be applied to the total 39^{th} order characteristic parameter containing 1^{st} and 2^{nd} order components to algebraic energy normalized to the 12^{th} order LPC-MEL spectrum coefficients. This process is typical for voice recognition processing and need not be discussed in further detail.

The voice recognition mode employing the voice characteristic parameter generates a phonetic decision tree for each state position and can be applied to a method for learning a state sequence of a context-sensitive audio model by a successive state splitting (SSS) using the learning voice data. Since the method rapidly performs the state-splitting, it can select a state to be split by the SSS and split it. Simultaneously, the method can perform state-splitting for a state that can be entirely split and can select the highest order of state. The voice UI processor 240 may employ a hidden Markov model as an audio model. The voice UI processor 240 can also employ a method for analyzing the frequency of a sound wave based on a variety of algorithms and extracts and splits a range of sound characterizing vowels or feathers equivalent to the range. It should be understood that the voice UI processor 240 can be implemented with various types of voice recognition algorithms as well as the voice recognition algorithm described above.

As described above, the portable terminal 100 according to the present invention generates the grip-state sensing signal and the squeeze-state sensing signal, based on the sensed signals of the sensing unit 170, and supports a user function corresponding to the signal. The portable terminal 100 can also generate commands required to control application programs by combining at least one of the grip-state sensing signal and the squeeze-state sensing signal with one of the touch event and the voice recognition signal, thereby providing various operation methods to the portable terminal user. In the following description, the operations of the portable terminal are explained, in detail, with reference to the drawings.

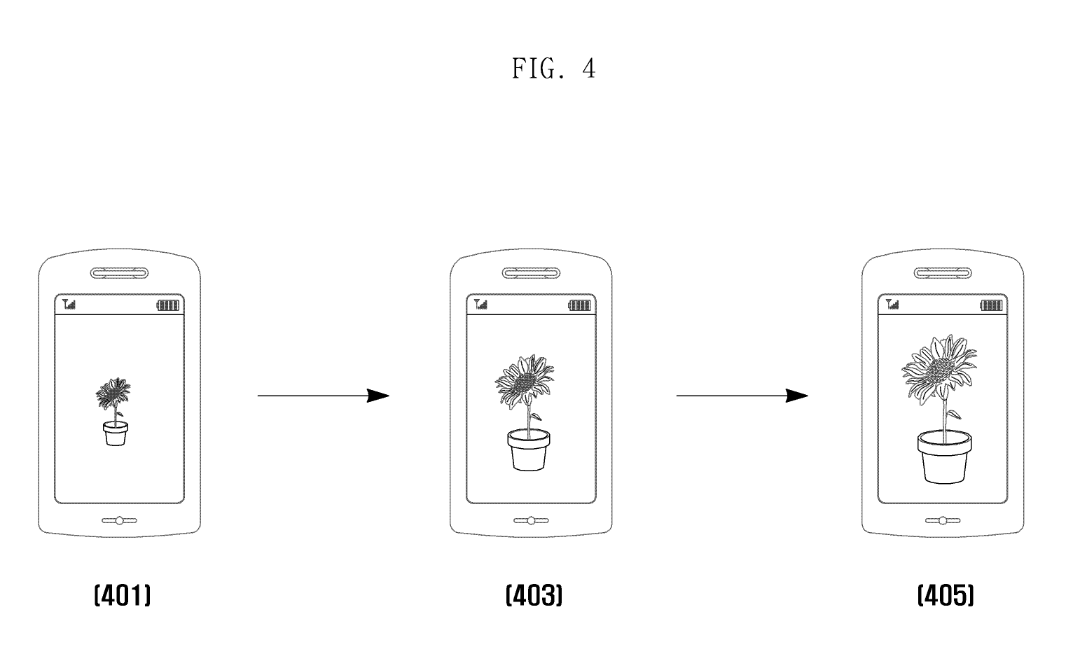

FIG. 4 shows screen views that describe a first embodiment of the operation of the portable terminal according to the present invention.

Referring to FIGS. 1 to 4, when a user grasps the portable terminal 100, increases a force applied to the sensing unit 170 installed to the side of the portable terminal 100, an image displayed on the display panel 141 is changed in size. More specifically, if the user applies a gripping force to the sensing unit 170 and the sensing unit 170 detects a force with a range, equal to or greater than 1 N but less than 2 N, the portable terminal 100 displays an image of a certain size on the display panel 141 as shown in diagram 401 of FIG. 4. After that, if the user applies a gripping force greater than a previous gripping force to the sensing unit 170 and the sensing unit 170 then detects a force in a range equal to or greater than 2 N but less than 3 N, the portable terminal 100 displays an image, larger than the image shown in diagram 401, on the display panel 141 as shown in diagram 403 of FIG. 4. That is, the portable terminal 100 zooms in on the image, displayed on the screen shown in diagram 401, and displays a larger image on the screen of the display panel 141, displayed on the screen shown in diagram 403, as the user holds the external body of the portable terminal with a force greater than that at a previous step. if the user continuously applies a force greater than a previously applied force to the sensing unit 170, while the image is being displayed on the screen shown in diagram 403, and the sensing unit 170 detects a force in the range, equal to or greater than 3 N but less than 4 N, the portable terminal 100 displays an image, even larger than the image shown in diagram 403, on the display panel 141 as shown in diagram 405 of FIG. 4. That is, in this exemplary example, the portable terminal 100 zooms the image, displayed on the screen shown in diagram 403, and displays a larger image on the screen of the display panel 141, displayed on the screen shown in diagram 405, as the user holds the external body of the portable terminal with a force greater than that at a previous step. Therefore, as the portable terminal user gradually increases the force applied to the external body of the portable terminal 100, the portable terminal 100 can detect the increased force and zoom in on an image currently being displayed on the display panel 141, in a stepwise manner, corresponding to the magnitude of the detected gripping force.

If the sensing unit 170 is implemented with a plurality of piezoelectric sensors, the pressure value according to a user's applied force can be calculated by averaging pressure values detected by each of the respective piezoelectric sensors. That is, although the user grasps the external body of the portable terminal and allows his/her fingers to make an effort to grip it with the same force, the respective piezoelectric sensors, installed on the external body, may detect different pressure values because the fingers are different in size, located in different positions on the piezoelectric sensors, and thus apply different forces thereto. Therefore, in one aspect of the invention, the pressure value, detected by the sensing unit 170, may be calculated by averaging the pressure values detected by the respective piezoelectric sensors rather than determined by a pressure value according to only a force of a particular finger.

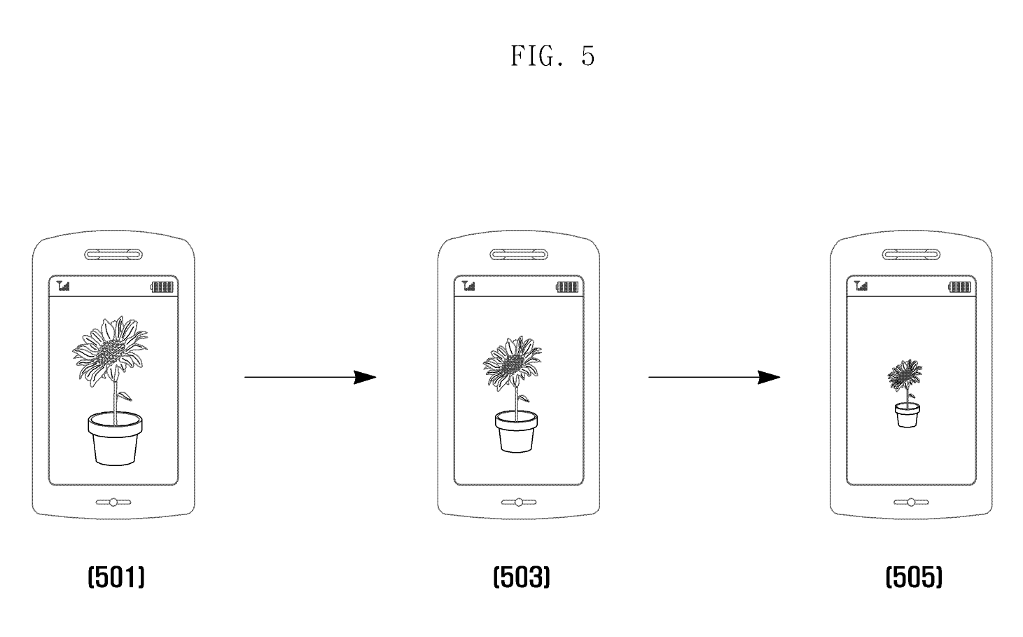

FIG. 5 shows screen views that describe a second embodiment of the operation of the portable terminal according to the present invention. It is assumed that the portable terminal user initially continues applying a force equal to or greater than 4 N to the sensing unit 170.

Referring to FIGS. 1 to 5, when a user grasps the portable terminal 100 and applies a force equal to or greater than 4 N to the sensing unit 170 installed to the side of the portable terminal 100, a zoomed-in image is displayed on the display panel 141. If the user reduces the force applied to the sensing unit 170, the image is correspondingly zoomed out and displayed on the display panel 141. More specifically, if the user applies a force to the sensing unit 170 and the sensing unit 170 then detects a force equal to or greater than 4 N, the portable terminal 100 displays an image of a certain size on the display panel 141 as shown in diagram 501 of FIG. 5. After that, if the user applies a smaller force than the previous force to the sensing unit 170 and the sensing unit 170 detects a force in the range equal to or greater than 2 N but less than 3 N, the portable terminal 100 displays an image smaller than the image shown in diagram 501, on the display panel 141 as shown in diagram 503 of FIG. 5. That is, the portable terminal 100 zooms out the image displayed on the screen shown in diagram 501, and displays a smaller image on the screen of the display panel 141, displayed on the screen as shown in diagram 503. If the user applies a smaller force than a previous force to the sensing unit 170, while the image is being displayed on the screen shown in diagram 503, and the sensing unit 170 detects a force in the range equal to or greater than 1 N but less than 2 N, the portable terminal 100 displays an image smaller than the image shown in diagram 503 on the display panel 141, as shown in diagram 505 of FIG. 5. That is, the portable terminal 100 zooms out of the image, displayed on the screen shown in diagram 503 and displays a smaller image on the screen of the display panel 141, as displayed on the screen shown in diagram 505. Therefore, as the portable terminal user gradually reduces a force applied to the external body of the portable terminal 100, the portable terminal 100 can detect the reduced magnitude of the applied force and zooms out the image being currently being displayed on the display panel 141 in a step-wise manner.

Although the embodiment is explained in such a way that a zoomed-in image is initially displayed by applying a force equal to or greater than a certain value to the external body of the portable terminal and then is step by step zoomed out by gradually reducing the force, it should be understood that the present invention is not limited to the embodiment described, herein. Rather, the embodiment presented herein may be modified in such a way that an image is being displayed as shown in diagram 501 only when the user applies a force equal to or greater than a certain value to the external body of the portable terminal 100, and then as the pressure is reduced from the previously applied force a smaller image as shown in diagrams 503 and 505 is displayed.

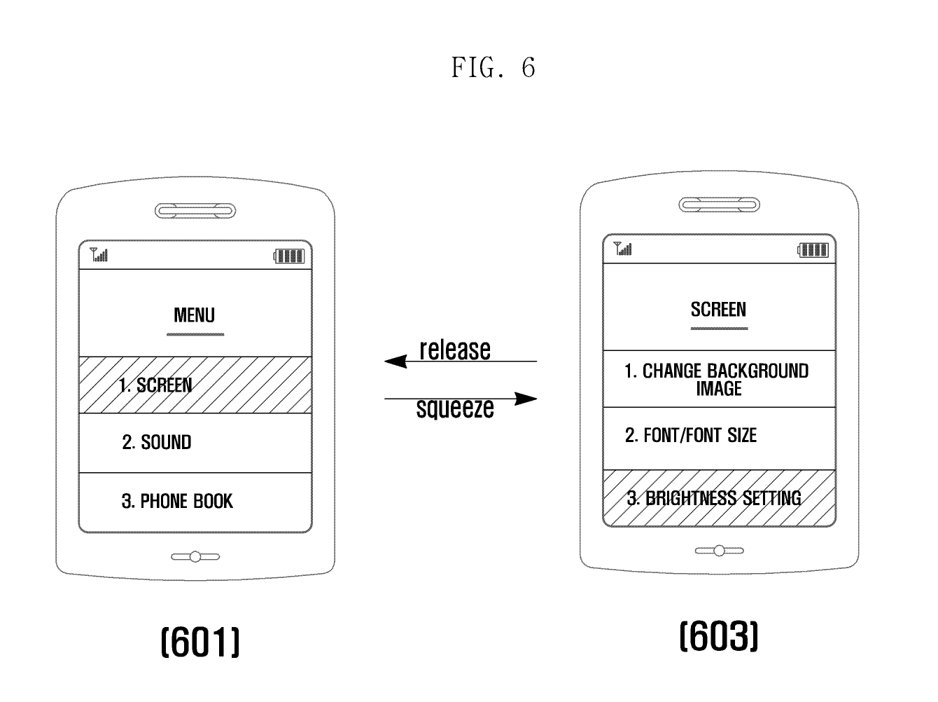

FIG. 6 shows screen views that describe a third embodiment of the operation of the portable terminal according to the present invention.

Referring to FIGS. 1 to 6, when the user grasps the portable terminal 100 and enables a menu function, the portable terminal 100 displays a menu screen on the display panel 141 as shown in diagram 601. More specifically, if the user holds the sensing unit 170 installed to the external body of the portable terminal 100 with a pressure value equal to or less than a certain value, the portable terminal 100 can detect a grip state. In that case, the sensing unit 170 generates a grip-state sensing signal and outputs it to the controller 160. The controller 160 generates a command for conducting a particular function based on the grip-state sensing signal. For example, the controller 160 can generate a command for displaying a menu screen according to the setting of the portable terminal 100 and display a menu screen based on the command. The controller 160 can also display a menu screen corresponding to a menu function according to an input signal of the input unit 120 or a touch event of the touch screen 140, if the menu screen is not set with a particular option.

If the user applies a force in the range greater than the certain value below which a grip signal is generated,(i.e., a grip state is changed to a squeeze state), to the sensing unit 170, the portable terminal 100 extends one of the menu items highlighted on the menu screen, “1. Screen,” in diagram 601 of FIG. 6 and displays a screen corresponding to “1. Screen” containing sub-items, as shown in diagram 603. After that, if the force applied to the external body is reduced to such an extent that the squeeze state is changed to the grip state the portable terminal 100 returns the screen shown in diagram 603 to the screen shown in diagram 601. That is, the portable terminal 100 according to the present invention can change the depth of the menu displayed according to the grip or squeeze-state sensing signals.

If a squeeze-state sensing signal corresponding to the certain pressure value is generated, the portable terminal 100 can display a menu screen as shown in diagram 601. If the pressure value is increased to and exceeds a value to distinguish between the levels of squeeze states, as previously described, the portable terminal 100 displays a sub-menu screen as shown in diagram 603. More specifically, if the user increases a force to change from a grip state, where an idle state is displayed to a first squeeze state, i.e., the user changes an applied force to be in the range equal to or greater than 1 N but less than 2 N, the portable terminal 100 displays a preset menu screen as shown in diagram 601. If the user increases the applied force to change from the first squeeze state showing the screen, which shows the screen view shown in diagram 601, to a second squeeze state, i.e., the user changes the applied force to be within a range e equal to or greater than 2 N but less than 3 N, the portable terminal 100 displays a sub-menu screen as shown in diagram 603, which corresponds to the menu item highlighted in the menu screen shown in diagram 601. On the other hand, if the menu item of the menu screen shown in diagram 601 does not have a sub-item, the portable terminal 100 outputs a message indicating that there is no sub-item, via a voice, a text, a vibration, etc.

If the user increases the applied force to change from a previous squeeze state where a particular sub-menu item, for example, ‘setting brightness,’ is highlighted, as shown in diagram 603, to a third squeeze state, i.e., the user changes the applied force to be in the range equal to or greater than 3 N but less than 4 N, the portable terminal 100 can perform a control operation in such a way that: if the sub-item, ‘setting brightness,’ has another sub-menu, it displays the sub-menu; but otherwise if the sub-item, ‘setting brightness,’ does not have another sub-menu, it displays a screen according to the activation of the brightness setting function.

After that, if the applied force is reduced to that of a previous pressure so that the current squeeze state can be changed to a previous squeeze state, the portable terminal 100 displays, in a step-wise manner, screens shown in diagrams 603 and 601.

As described above, the portable terminal 100 according to the present invention displays a particular screen, according to the changes in the pressures applied to the sensing unit 170. The portable terminal 100 can also display a screen linked to a corresponding one of the items displayed on the particular screen or perform a function of the corresponding item. The portable terminal 100 can return the screen on which the item linked to a corresponding function is being displayed or the screen linked to the function to the previous screen.

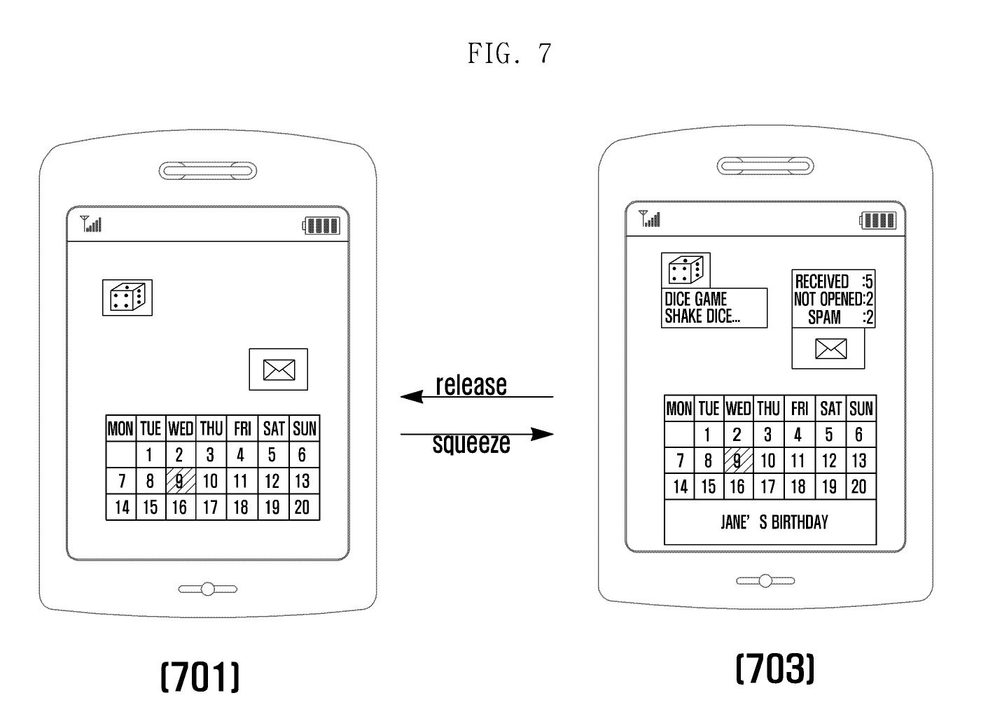

FIG. 7 shows diagrams that describe a fourth embodiment of the operation of the portable terminal according to the present invention.

Referring to FIGS. 1 to 7, the portable terminal 100 displays an idle screen according to a user's setting or the settings of the portable terminal 100. On the idle screen, a variety of icons set by a user or as default are displayed as shown in diagram 701. The icons include function icons for executing particular functions, for example, a game icon for executing a game function, a menu icon for executing a message function, a schedule icon for executing a schedule function, etc. The idle screen is displayed after electrical power is supplied to the portable terminal 100 or when a particular input signal is input in a sleep mode. In an embodiment of the present invention, if a current state is changed to a grip state as the user applies a force in the range equal to or less than a preset value to the sensing unit 170 installed to the external body of the portable terminal 100, the idle screen is displayed as shown in FIG. 701. In another aspect of the invention, if the user grasps the sensing unit 170, no actions may be taken when a grip state is detected. However, as the force applied increases from an extent that the grip state is changed to a squeeze state, the idle screen can be displayed as shown in FIG. 701.

After that, if the user increases the applied force to such an extent that the grip state can be changed to a squeeze state or increases the applied force to such an extent that a first squeeze state can be changed to a second squeeze state, the portable terminal 100 can output a text related to functions of icons displayed on the idle screen, as shown in diagram 703. More specifically, if the user increases the applied force while the screen shown in diagram 701 is being displayed and thus the sensing unit 170 detects the increased force, the portable terminal 100 can output a manual for describing the function regarding each icon, via a text, a still or moving image, etc. For example, if the manual corresponds to a game icon, the portable terminal 100 can output information regarding the type of game, and game rules, that can be executed based on the game icon, to an area near the game icon image. Likewise, if the manual corresponds to a message icon, the portable terminal 100 can output information, such as the number of received messages, the number of missed messages, the number of spam messages, etc., to an area near the message icon. In addition, if the manual corresponds to a schedule icon, the portable terminal 100 can output daily schedule information to an area near the schedule icon. On the other hand, if the applied force is removed from the sensing unit 170, the portable terminal 100 removes the displayed text or image from the screen.

As described above, the portable terminal 100 according to the present invention can display icon information on one side of the screen, according to the changes in the pressure values applied to the external body thereof.

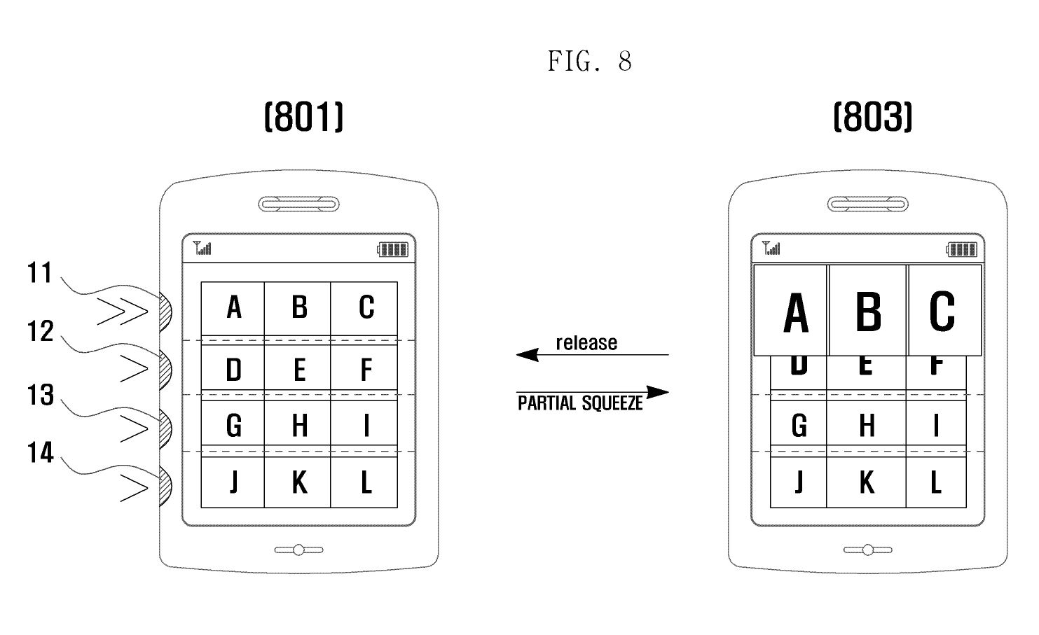

FIG. 8 shows diagrams that describe a fifth embodiment of the operation of the portable terminal according to the present invention. In the fifth embodiment, the portable terminal 100 is configured in such a way that four piezoelectric sensors are installed, spaced apart from each other with the same distance, to the left side of the external body, with respect to the display panel 141. When the user grasps the portable terminal 100 with his/her right hand, the four fingers are placed at and contact the four sensors, respectively. The four piezoelectric sensors are placed at the external body from the top left to the bottom left, spaced apart from each other with the same distance and their positions correspond to the index, middle, ring, and little fingers. For sake of convenience, the four fingers, index, middle, ring, and little fingers, are numbered as 11, 12, 13 and 14 and placed on the four piezoelectric sensors installed to the left side of the external body of the portable terminal 100.

Referring to FIGS. 1 to 8, when the user grasps the portable terminal 100 with his/her right hand so that the four fingers are placed on and contact the four piezoelectric sensors, the portable terminal 100 detects the pressure according to the contact made by the fingers. If the portable terminal 100 detects a pressure value equal to or less than a preset value, the portable terminal determines that its external body is in a grip state. After that, the portable terminal 100 can perform a user function, according to a signal input to the input unit 120 or a touch event that occurred on the touch screen 140. An example of the user function is to output multi-images for searching files as shown in diagram 801. The portable terminal 100 can display a certain number of multi-images arrayed on the display panel 141, for example, 12 multi-images, according to the multi-image output function. The portable terminal 100 can also perform a multi-image output function according to a grip state or a squeeze state, determined by the distribution of the pressure values detected by the sensing unit 170, irrespective of the signal input to the input unit 120 or the touch event that occurred on the touch screen 140. To this end, if the sensing unit 170 outputs a sensed signal to indicate a grip state or a squeeze state, the portable terminal 100 needs an option to perform a multi-image output function. This option can be configured as the portable terminal user operates the touch screen 140 or the input unit 120 or designed by the portable terminal manufacturer.

If the user applies a force greater than that at the previous step to a particular portion of the external body (i.e., a single sensor) while a screen is being displayed as shown in diagram 801, the portable terminal 100 can detect the distribution of pressure values according to the action. More specifically, when the user holds the external body of the portable terminal 100 with his/her right hand, the index finger 11, the middle finger 12, the ring finger 13, and the little finger 14 are placed in order on the left side of the external body from the top left to the bottom left. In an embodiment of the present invention, the sensing unit 170 is comprised of four piezoelectric sensors corresponding to the fingers 11, 12, 13, and 14, respectively. In that case, the sensing unit 170 can detect the pressure values and the distribution of the pressure values, according to the forces applied by the respective fingers 11, 12, 13, and 14. For example, if the user generates a larger force with a particular finger, (the index finger 11), than those of the remaining fingers 12, 13, and 14, the portable terminal 100 can display a region of the display panel 141, to which the relatively larger force is applied, larger than other regions as shown in diagram 803. That is, the portable terminal 100 displays the “A, B, C” content images larger than other content images. In particular, the larger A, B, C content images may overlap the upper portion of part of the other content images, for example, the “D, E, F” content images. During this process, the portable terminal 100 can display the remaining content images except for the “A, B, C” content images, i.e., “D, E, F, G, H, I, J, K, L,” in the same size as they are in a previous step. To this end, the portable terminal 100 divides the display area of the display panel 141 into four regions corresponding to the positions of the four piezoelectric sensors of the sensing unit 170, and maps the four regions to the four piezoelectric sensors, respectively. Therefore, the portable terminal 100 can be operated in such a way that, if one of the piezoelectric sensors experiences the largest applied force, it can display the display region corresponding to the piezoelectric sensor, in a type, for example, a zoomed-in type according to a zooming-in function, which differs from the types of the display regions corresponding to the remaining piezoelectric sensors.

After that, when the force applied to the particular piezoelectric sensor is reduced, the portable terminal 100 detects the reduced force and reinstates the screen shown in diagram 803 as the screen shown in diagram 801. Although the embodiment of the present invention is explained in such a way that the portable terminal 100 allows a particular regions to perform a function that differs from functions of other regions according to the increase of a force applied to a particular piezoelectric sensor, it should be understood that the present invention is not limited to the embodiment. For example, if the user's index and middle fingers 11 and 12 hold the corresponding piezoelectric sensors with an applied force greater than those of the remaining fingers, the portable terminal 100 performs a function at the display regions corresponding to the piezoelectric sensors installed at the areas where the index and middle fingers 11 and 12 are located, for example, a zoom-in function that zooms in an image displayed on the display regions, The function differs from that at the other display regions.

Although the embodiment of the present invention is explained in such a way that at least one of the image and text, displayed on a display region corresponding to a piezoelectric sensor to which a relatively large gripping force is applied, is zoomed in larger than the image and text displayed on display regions corresponding to the remaining piezoelectric sensors, it should be understood that the present invention is not limited to the embodiment. For example, the embodiment can be modified in such a way that at least one of the image and text, displayed on a display region corresponding to a piezoelectric sensor to which a relatively large force is applied, is zoomed out to be smaller than the image and text displayed on display regions corresponding to the remaining piezoelectric sensors.

As described above, the portable terminal 100 according to the present invention divides the display area into the number of piezoelectric sensors included in the sensing unit 170, determines the distribution of pressure values corresponding to the gripping forces applied to the piezoelectric sensors, and zooms-in on an image or text, displayed on a display area corresponding to a piezoelectric sensor to which a particular force is applied, larger than an image or text displayed on other display areas according to the change in the particular pressure value.

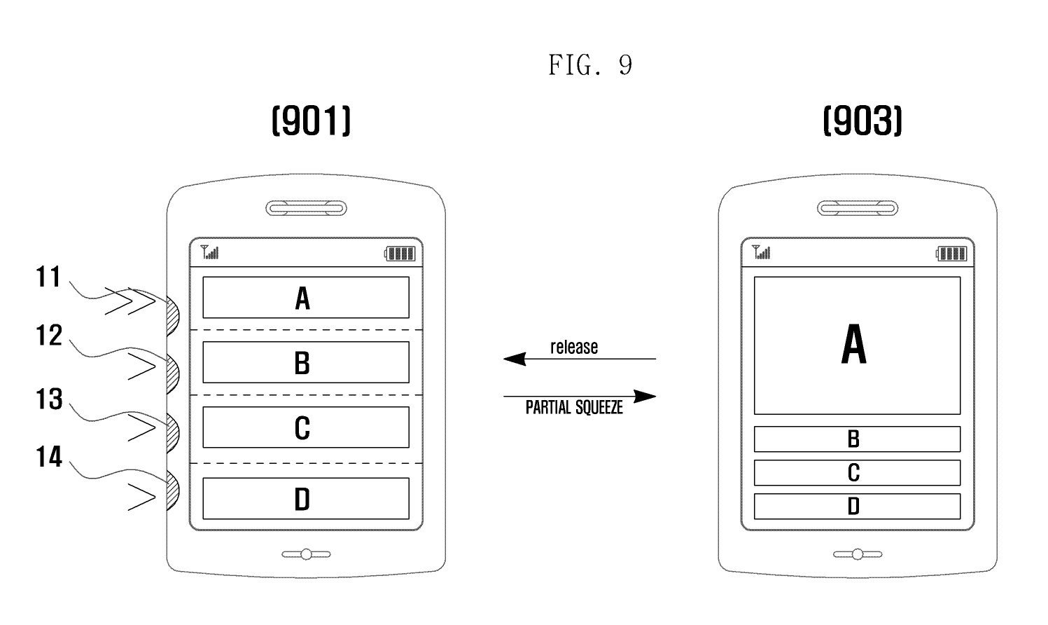

FIG. 9 shows diagrams that describe a sixth embodiment of the operation of the portable terminal according to the present invention. In this exemplary embodiment it is assumed that the portable terminal shown in FIG. 9 is configured in such a way that a certain number of piezoelectric sensors are installed, spaced apart from each other with the same distance, to the left side of the external body, like the embodiment of FIG. 8. It is also assumed that the user grasps the portable terminal with his/her right hand. It should be, however, understood that the present invention is not limited to the embodiment. For example, the embodiment can be modified in such a way that a certain number of piezoelectric sensors are installed, spaced apart from each other with the same distance, to the right side of the external body. In that case, the user can grasp the portable terminal with his/her left hand.

Referring to FIGS. 1 to 9, the portable terminal 100 can display particular content on a display panel 141, according to a user's request, as shown in diagram 901. That is, if a user generates an input signal for searching for content, the portable terminal 100 displays content corresponding to the input signal, in a preset format, on the display panel 141. For example, the portable terminal 100 can display four contents, in an array order, from the upper position to the lower position, on the display panel 141. The content displaying operation can be performed by selecting a menu function or by inputting a hot key. The content displaying operation can also be performed when the portable terminal 100 detects a grip state or a squeeze state, according to the option, where the squeeze state refers to a state where a pressure value as previously described is applied to the portable terminal. The user's fingers 11, 12, 13 and 14 can be located at the positions corresponding to the display regions on which the four contents are displayed. The plurality of piezoelectric sensors included in the sensing unit 170, for example may be installed at the positions in which the fingers 11, 12, 13 and 14 are located, respectively.

If a particular user's finger, for example, the index finger 11, applies a force greater than that of the remaining fingers to a corresponding piezoelectric sensor, the portable terminal 100 ascertains that the piezoelectric sensor corresponding to the index finger 11 detects a pressure value greater that of the piezoelectric sensors corresponding the remaining fingers and In that case, the portable terminal 100 can display content, displayed on the display region adjacent to the area where the index finger 11 is located, so as to be distinguished from the content displayed on the other display regions. For example, as shown in diagram 903, the portable terminal 100 zooms in on the ‘A’ content image displayed on the display region corresponding to the area where the index finger 11 is located. When the ‘A’ content image is zoomed in and displayed on the display region, other ‘B, C, D’ content images are displayed smaller than those at their previous step.

As described above, the portable terminal 100 according to the present invention performs a control operation in such a way that the content displayed on the display regions can be changed according to the distribution of the force applied to the individual piezoelectric sensors, so that the portable terminal user can easily search for corresponding contents.

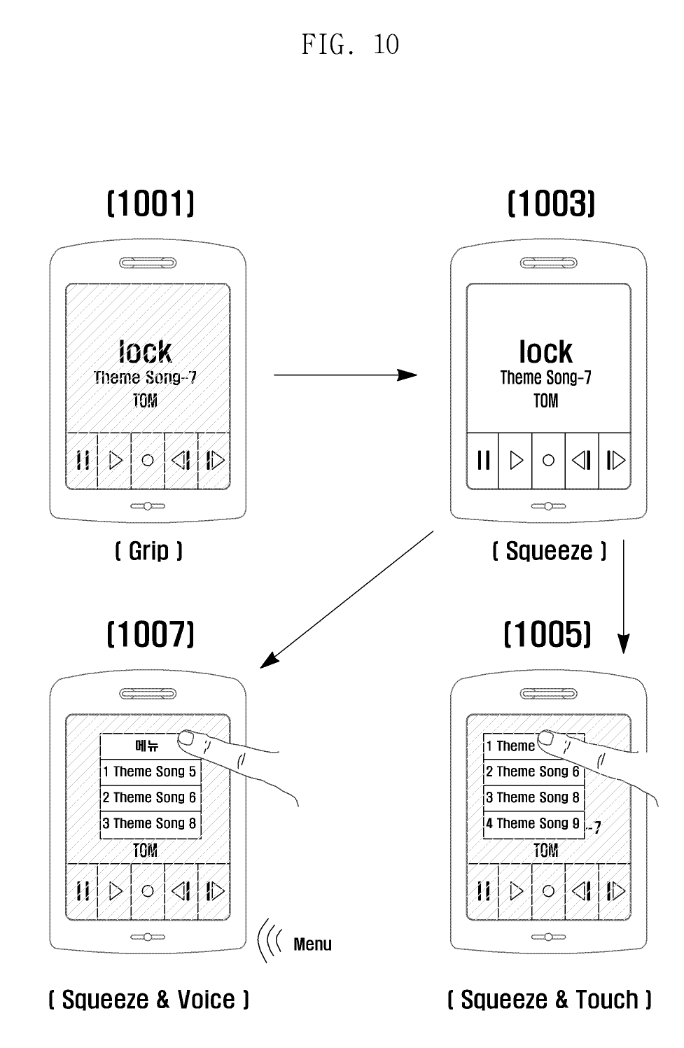

FIG. 10 shows diagrams that describe a seventh embodiment of the operation of the portable terminal according to the present invention. In this exemplary embodiment, it is assumed that the portable terminal 100 is operated in a sleep state according to a user's request or because no input signal is generated for a preset period of time. The portable terminal 100 can turn off the display panel 141 to reduce the consumption of electrical power in a sleep state.

Referring to FIGS. 1 to 10, when a user grips the external body of the portable terminal 100 operated in a sleep mode, the portable terminal 100 detects the force applied to the sensing unit 170 installed to the external body. The sensing unit 170 is configured to generate a sensed signal according to an external force applied to itself without external electrical power, so it may not need to be connected to a power supply of the portable terminal 100. If the user applies a force greater than a certain value to the external body, the sensing unit 170 detects the applied force (pressure). If the detected pressure value is equal to or less than a preset value, the portable terminal 100 ascertains that the current state is a grip state. In this case, the portable terminal 100 displays a screen, provided by a currently enabled application program, on the display panel 141 as shown in diagram 1001. For example, if the portable terminal 100 does not receive an input signal for a preset period of time while an application program for a file playback function is being enabled, its current state is changed to a sleep state. After that, if the portable terminal 100 receives a sensed signal corresponding to the grip state from the sensing unit 170, it reconfigures and displays a screen image based the image that was displayed on the display panel 141 immediately before its state is changed to the sleep state, or configures and displays a screen image corresponding to a time point when the currently enabled application program is executed. In that case, the portable terminal 100 can be operated based on a command corresponding to the grip state. That is, the portable terminal 100 displays a screen corresponding to a file playback function on the display panel 141, thereby informing the user of a currently played file. The portable terminal 100 may set the current state to a lock state where a touch event that occurred on the touch panel 143 or an input signal from the input unit 120 cannot be applied to an application program. The setting operation can be performed referring to the command table 161. To this end, the command table 161 stores a lock state setting command for blocking a file playback control signal if a state where a file playback function is enabled is changed to a sleep state and then a sensed signal corresponding to a grip state is generated. The command can be designed by the user or the portable terminal manufacturer.

While the portable terminal 100 is enabling the file playback function in a lock state as shown in diagram 1001, it can also output audio signals according to the enabled file playback function. After that, if the user applies a force greater than the certain value to the sensing unit 170, the portable terminal 100 receives a sensed signal from the sensing unit 170 and ascertains that the user intends to change a grip state to a squeeze state. In that case, the portable terminal 100 generates a command indicating a squeeze state during the activation of a file playback function, i.e., a command for changing a lock state to an unlock state, referring to the command table 161, and then performs a control operation according to the squeeze state command. After that, the portable terminal 100 is operated in a mode where a touch screen 140 is available as shown in diagram 1003. Alternatively, the portable terminal 100 can change the lock state, shown in diagram 1001, to a state where the input unit 120 can receive an input signal for controlling the file playback function.

As shown in diagram 1003, if the user to apply a force greater than the certain value to the sensing unit 170 to maintain a squeeze state and a touch event occurs on the other area except the area of the display panel 141 for controlling a file playback operation, (for example, on an area of the touch panel 143 corresponding to an area of the display panel 141 on which an image contained in an enabled file), the portable terminal 100 displays a menu screen on one side of the touch screen 140 as shown in diagram 1005. That is, if a squeeze-state sensing signal and a particular touch event are generated, the portable terminal 100 generates a command for displaying a menu screen and then displays the menu screen on one side of the touch screen 140.

As shown in diagram 1003, if a squeeze-state sensing signal is generated as the user continues to apply a force greater than the certain value to the sensing unit 170 and a voice recognition signal corresponding to an input voice signal is generated according to the activation of the voice recognition function, the portable terminal 100 displays a menu screen as shown in diagram 1007. That is, if a squeeze-state sensing signal and a particular voice recognition signal are generated, the portable terminal 100 generates a command for display a menu screen and then displays the menu screen. To this end, if the current state is a squeeze state, the portable terminal 100 activates a microphone MIC for supporting a voice recognition function and operates the voice recognition function based on an audio signal acquired by the microphone MIC.

As described above, the portable terminal 100 according to the present invention can perform a control operation according to the grip state and the squeeze state. While the portable terminal 100 is being operated in a squeeze state, it can perform a particular user function, by further using a touch event and a voice recognition function. Although the embodiment has been explained in such a way that the portable terminal may further use a touch event and a voice recognition function during the squeeze state, it should be understood that the portable terminal may also use a touch event and a voice recognition during the grip state. In that case, the portable terminal 100 can generate a command according to a combination of a grip state and a touch event or a combination of a grip state and a voice recognition function and control a particular user function based on the generated command.

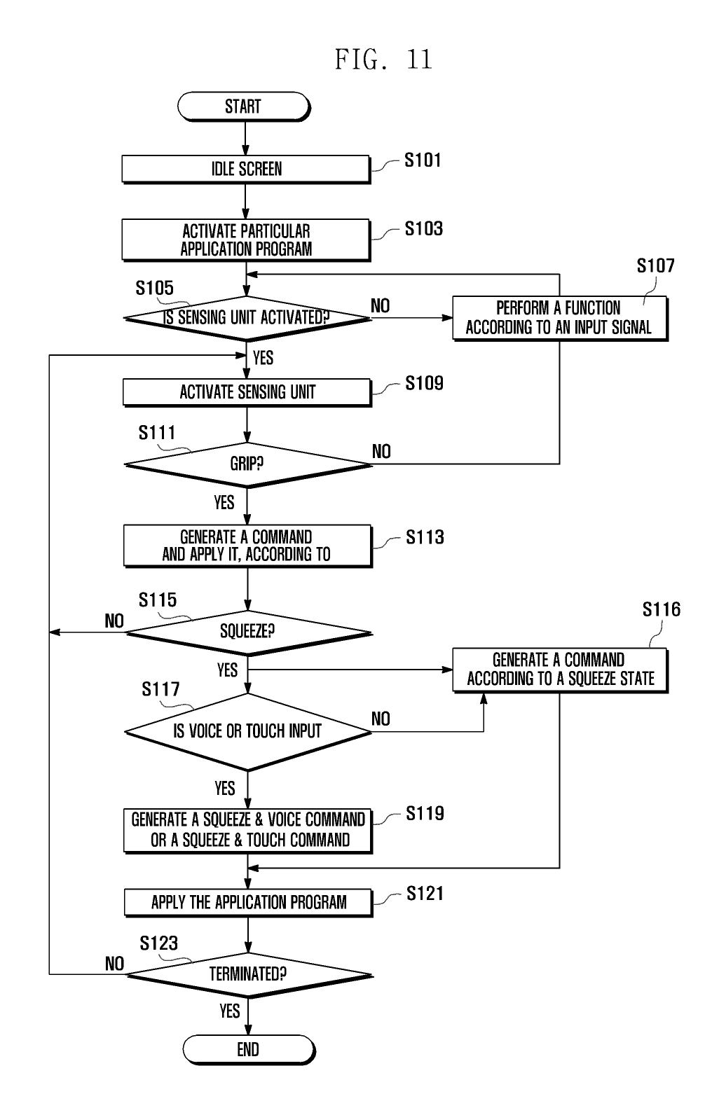

In the foregoing description, the input device of the portable terminal and the screen interface according to the operation thereof has been explained. The following description provides an input method based on the input device of the portable terminal with reference to FIG. 11.

FIG. 11 shows a flow chart that describes an input method of a portable terminal according to an embodiment of the present invention.

Referring to FIGS. 1 to 11, the portable terminal 100 is turned on and initializes elements included therein. After completing the initialization, the portable terminal 100 displays a preset idle screen on the display panel 141 (S101). When the portable terminal 100 is activated from a sleep mode because it does not receive an input signal for a preset period of time, it can also display the idle screen on the display panel 141. If the display panel 141 is enabled, the portable terminal 100 receives a user's request and enables the touch panel 143 so that it can recognize the user's touch.

After that, the portable terminal 100 enables a particular application program according to a user's request (S103). If the user intends to activate a particular user function via the input unit 120 or the touch screen 140, the portable terminal 100 activates the user function according to an input signal of the input unit 120 or a touch event of the touch screen 140. Examples of the user function are a file playback function, a file search function, a camera function, a web connection function, a call function, a phonebook function, a schedule function, etc.

After enabling a particular application program at step S103, the portable terminal 100 determines whether the sensing unit 170 is enabled (S105). That is, the portable terminal 100 determines whether to control an application program in a grip state or a squeeze state according to the magnitude of a user's force applied to the sensing unit 170. In an embodiment of the present invention, the sensing unit 170 is activated at step S105 in such a way that a determination is made whether to supply electrical power to the sensing unit 170 and then its hardware is initialized. Alternatively, the sensing unit 170 may be activated before step S101 and then operated in a standby mode. That is, the portable terminal 100 may be set in such a way that the sensing unit 170 is activated as a default, according to a user's setting. If the portable terminal 100 ascertains that the sensing unit 170 is not enabled at step S105, it performs a user function according to a signal input to the input devices, such as the input unit 120, the touch panel 143, the microphone MIC for voice recognition, etc. (S107).

However, if the portable terminal 100 ascertains that the sensing unit 170 is enabled at step S105, it activates the sensing unit 170 (S109). After that, the portable terminal 100 determines whether a current state is a grip state where a force equal to or less than a preset value is applied to the sensing unit 170. If the portable terminal 100 ascertains that a current state is not a grip state at step S111, it returns to and proceeds with step S107. However, if the sensing unit 170 ascertains that a current state is a grip state at step S111, it generates a command according to the grip state (S113). The portable terminal 100, receiving an indication of a grip state, performs a control operation according to the generated command. To this end, the portable terminal 100 refers to the command table 161 stored in the storage unit 150.

After that, the portable terminal 100 determines whether the current sate is changed to a squeeze state (S115). If the portable terminal 100 ascertains that the current sate is not changed to a squeeze state at step S115, it returns to and proceeds with step S109. However, if the portable terminal 100 ascertains that a pressure value equal to or greater than that at a previous stage is applied to the sensing unit 170 at step S115, it concludes that the current sate is changed to a squeeze state and generates a command according to the squeeze state, referring to the command table 161 (S116). The squeeze state may be divided into a plurality of sub-squeeze states according to the pressure values according to the ranges of forces applied to the sensing unit 170. In that case, the portable terminal 100 can generate commands corresponding to the sub-squeeze states, respectively. The portable terminal 100 can also perform different functions according to the sub-squeeze states, for example, a zooming-in or -out function. If a plurality of piezoelectric sensors, installed and spaced apart from each other with the same distance on the external body, acquires different pressure values, the portable terminal 100 generates a command according to the distribution of the different pressure values and controls an application program based on the generated command. For example, if a piezoelectric sensor detects a pressure value according to a force that is greater than that applied to the other piezoelectric sensors, the portable terminal 100 can display an image or a text, displayed on a display area of the display panel 141 corresponding to the position of the piezoelectric sensor, in a certain type that differs from types of the images or texts displayed on display areas of the display panel 141 corresponding to the positions of the other piezoelectric sensors.

However, if the portable terminal 100 ascertains that the current sate is changed to a squeeze state at step S115, it determines whether a voice signal is input or a touch event occurs (S117). To this end, the portable terminal 100 enables the microphone MIC and performs a voice recognition operation with respect to audio signals output from the microphone MIC. If the portable terminal 100 ascertains that the touch panel 143 is not enabled, it enables the touch panel 143. If the portable terminal 100 ascertains that a voice signal or a touch event is not generated at step S117, and the processing proceeds to step S116.

However, if the portable terminal 100 ascertains that a voice signal or a touch event is generated at step S117, a command according to the squeeze state and the voice recognition or a command according to the squeeze state and the touch event is generated (S119). After that, the portable terminal 100 enables the application program according to the generated (combined) commands (S121). The commands of step S121 include those of step S116. After that, the portable terminal 100 determines whether a signal for terminating the application program or the portable terminal is input (S123). If the portable terminal 100 ascertains that a signal for terminating the application program or the portable terminal is not input at S123, processing proceeds to step S109. However, if the portable terminal 100 ascertains that a signal for terminating the application program or the portable terminal is input at S123, it terminates the procedure.

As described above, the input method and input device of a portable terminal, according to the present invention, can generate commands to be applied to a currently enabled application program based on a grip state or a squeeze state and also a particular command by combining signals generated by other input devices, such as a touch panel, a voice recognition-based input device, etc. Therefore, the input method and input device of a portable terminal can more rapidly generate commands required to operate the portable terminal and also a variety of commands by combining other input signals.

The above-described methods operable in the controller according to the present invention can be realized in hardware or as software or computer code that can be stored in a recording medium such as a CD ROM, an RAM, a floppy disk, a hard disk, or a magneto-optical disk or downloaded over a network (i.e., The controller may include or access a computer program that can be provided from an external source which is electronically downloaded over a network, e.g., Internet, POTS, so that the methods described herein can be rendered in such software using a general purpose computer, or a special processor or in programmable or dedicated hardware, such as an ASIC or FPGA. As would be understood in the art, the controller in the form of a computer, a processor or programmable hardware include memory components, e.g., RAM, ROM, Flash, etc. that may store or receive software or computer code that when accessed and executed by the computer, the processor or the hardware implement the processing methods described herein. The code when loaded into a general purpose computer transformed the general purpose computer into a special purpose computer that may in part be dedicated to the processing shown herein. In addition, the computer, the processor or the hardware may be composed of at least one of a single processor, a multi-processor, and a multi-core processor.

As described above, the input method and device of a portable terminal, according to the present invention, can generate a variety of input signals according to the magnitude of pressure applied to a sensor located at one side of a portable terminal and by associating with other functions, such as a touch function or a voice recognition function, thereby providing more convenient and dynamic user functions.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. An input method, operable in a processor of a portable terminal comprising:
detecting a pressure value corresponding to a mechanical force applied to the portable terminal;
determining whether the pressure value is equal to or less than a preset value;
ascertaining that a current state is a grip state if the pressure value is equal to or less than the preset value and that a current state is a squeeze state if the pressure value is greater than the preset value;
generating commands according to the grip state and the squeeze state; and
applying the generated commands to a currently enabled application program.

2. The input method of claim 1, further comprising:
dividing the pressure value greater than the preset value into a plurality of non-overlaying pressure ranges; and
identifying a plurality of sub-squeeze states based on a corresponding one of the pressure ranges.

3. The input method of claim 2, wherein the step of generating commands comprises:
generating different commands corresponding to the plurality of sub-squeeze states.

4. The input method of claim 2, wherein step of generating commands comprises:
generating a command, wherein the command zooms in , in a step-wise manner, at least one image or text, displayed on a display panel according to the activation of a display application program, based on the determined sub-squeeze state;
generating a command, where in the command zooms out, in a step-wise manner at least one image or text, displayed on a display panel according to the activation of the display application program, based on the determined sub-squeeze state.

5. The input method of claim 1, wherein detecting a pressure value comprises:
applying the mechanical force to a plurality of sensors installed to an external body of the portable terminal; and
detecting pressure values received by each of the plurality of sensors.

6. The input method of claim 5, wherein the pressure value is determined as an average value of the detected pressure values

7. The input method of claim 5, wherein generating commands comprises:
generating commands according to the distribution of each of the detected pressure values.

8. The input method of claim 5, wherein applying the generated commands to a currently enabled application program comprises one of the following steps of:
displaying at least one of an image and an text, displayed according to the activation of the application program, on a display area corresponding to a sensor to which a pressure is applied which differs from the display areas corresponding to the remaining sensors; and
zooming-in or -out at least one of an image and an text, displayed on a display area corresponding to a sensor to which a pressure is applied, so that the zooming-in or -out image and/or text is displayed larger than or smaller than at least one of images and texts displayed on display areas corresponding to the reaming sensors.

9. The input method of claim 1, further comprising:
detecting at least one of a touch event that occurs on a touch panel, an input signal generated in an input unit, and a voice recognition signal generated from an audio signal acquired by a microphone.

10. The input method of claim 9, wherein generating commands comprises at least one of the following steps of:
generating a command by combining at least one of the touch event, the input signal and the voice recognition signal with a grip-state sensing signal according to the grip state and a squeeze-state sensing signal;
generating, if the grip state is changed to the squeeze state according to the change in the applied pressure value, a command corresponding to the change; and
generating, if at least one of the touch event, the input signal and the voice recognition signal is generated during the squeeze state, at least one of the commands corresponding to a combination of the squeeze state and the touch event, a combination of the squeeze state and the input signal, and a combination of the squeeze state and the voice recognition signal.

11. An input device of a portable terminal comprising:
a sensing unit for detecting a pressure value corresponding to a mechanical force applied to the portable terminal;
a controller for:
determining whether the pressure value is equal to or less than a preset value,
ascertaining that a current state is a grip state if the pressure value is equal to or less than the preset value and that the current state is a squeeze state if the pressure value is greater than the preset value,
generating commands according to the ascertained grip state and the squeeze state, and
applying the generated commands to a currently enabled application program; and
a storage unit for storing the application program.

12. The input device of claim 11, wherein the pressure greater than the preset value is divided into a number of ranges corresponding to sub-squeeze states, and commands corresponding to sub-squeeze states are generated according to the applied pressure.

13. The input device of claim 12, further comprising:
a display panel for displaying an image or a text that is zoomed-in or zoom-out according to the corresponding sub-squeeze state.

14. The input device of claim 11, wherein the sensing unit comprises a plurality of sensors for detecting pressure corresponding to the mechanical forces applied thereto, the plurality of sensors being installed at corresponding positions of the portable terminal.

15. The input device of claim 14, wherein the controller ascertains that a current state is a grip state if the average of the detected pressure values, detected by the plurality of sensors, is equal to or less than the preset value and that a current state is a squeeze state if the average of the detected pressure values is greater than the preset value.

16. The input device of claim 14, wherein the controller generates a command according to the distribution of the detected pressure values detected by the plurality of sensors.

17. The input device of claim 14, further comprising:
a display panel for displaying at least one of an image and a text according to the activation of the application program:
wherein:
the display panel comprises a plurality of display areas corresponding to the plurality of sensors, respectively; and
the display panel displays at least one of an image and a text, displayed on a display area corresponding to a sensor to which pressure is applied, in a type that differs from that of at least one of images and texts displayed on display areas corresponding to the reaming sensors.

18. The input device of claim 11, wherein, if the grip state is changed to the squeeze state according to the change in the pressure value, the controller generates a command corresponding to the change.

19. The input device of claim 11, further comprising at least one of the following:
a touch panel for generating a touch event;
an input unit for generating an input signal; and
a microphone for acquiring audio signals.

20. The input device of claim 19, wherein, if at least one of the touch event, the input signal and the voice recognition signal and at least one of a grip-state sensing signal according to the grip state and a squeeze-state sensing signal according to the squeeze state are generated, the controller generates a command according to generated combination of the at least one touch event, input signal and voice recognition signal and at least one grip-state sensing signal and squeeze state signal.
